(19) United States
(12) Patent Application Publication
(10) Pub. No.: US 2021/0213478 A1
(43) Pub. Date: Jul. 15, 2021

(54) JETTER NOZZLE ASSEMBLY WITH REDUCED THREAD EXPOSURE

(71) Applicant: Paul DEL PIERO, Sunrise Beach, TX (US)

(72) Inventor: Paul DEL PIERO, Sunrise Beach, TX (US)

(21) Appl. No.: 17/120,539

(22) Filed: Dec. 14, 2020

Related U.S. Application Data
(60) Provisional application No. 62/960,411, filed on Jan. 13, 2020.

(51) Int. Cl. B05B 15/65; B08B 9/032; B05B 1/06

(52) U.S. Cl. CPC B05B 15/65; E03C 1/306; B05B 1/06; B08B 9/0321

(57) ABSTRACT

A jetter nozzle has a body with a plurality of orifices opening to an exterior of the body and adapted to release a pressurized liquid from an interior of the body, and a sleeve extending from one end of the body. The sleeve has an internally threaded portion adjacent to the body and an unthreaded portion adjacent to an end of the sleeve opposite the body. The threaded portion is adapted to engage with some external threads of a hose fitting. The end of the sleeve is adapted to be positioned adjacent a wrench face of the hose fitting and to reside over other external threads of the hose fitting.

### CROSS-REFERENCE TO RELATED APPLICATIONS

The present application claims priority from U.S. Provisional Patent Application Ser. No. 62/960,411, filed Jan. 13, 2020, and entitled “Jetter Nozzle Assembly With Reduced Thread Exposure”.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates generally to apparatus for removing obstructions from sewers, drains and pipe. More particularly, the present invention relates to jetter nozzles that emit a strong stream of fluid for the purposes of removing obstructions. Furthermore, the present invention relates to jetter nozzle assemblies with reduced thread exposure.

### 2. Description of Related Art Including Information Disclosed Under 37 CFR 1.97 And 37 CFR 1.98

Prior methods for removing build-up or obstructions from sewers, pipes and drain lines include the use of chemicals, mechanical cutters, and jetter nozzles. A jetter nozzle is connected to a hose and a water supply. The jetter nozzle advances forwardly in a sewer line or pipe by spraying jets of water rearwardly and radially outwardly at an angle from horizontal. A jetter nozzle typically provides for a single forwardly directed stream of water. However, the bulk of the cleaning action is limited to along the walls of the pipe or sewer line rearwardly of the nozzle. The cleaning results from the rearwardly directed streams of water impinging on the pipe or sewer wall. Although the forwardly-directed stream is capable of eroding a hole through certain materials, such nozzles have difficulty impinging the sewer wall. Jetter nozzles are typically used for removing build-up that is relatively soft, such as grease or organic waste.

In the past, jetter nozzles have been known to have inadequate performance. In these prior art jetter nozzles, the outside shape of the nozzle inhibits the ability to corner in rough and small diameter pipe elbows. The back jets typically have an angle of greater than twenty-five degrees. As such, the backjets provide less pulling force while being directed through the pipe or sewer. These prior art jetter nozzles have an excessive length which is caused by a poor matching of thread depths, the depth of the internal seating surface, and the washer thickness. This inhibits cornering in short radius elbows. Additionally, the selection of nozzle orifice size is not optimized for use with consumer pressure washers.

Typically, in prior art jetter nozzles, there is a body or jetter head for the nozzle which is threadedly secured onto a hose fitting. Typically, the body of the jetter nozzle will have exterior surfaces which facilitate the ability to apply a wrench and to rotate the body of the jetter nozzle around threads of the hose fitting. Also, the hose fitting will have a wrench surface thereon so as to provide a secure grip to the installer during the application of the body of the jetter nozzle onto the threads of the hose fitting.

FIGS. 1 and 2 shows such prior art jetter nozzles assembly. As can be seen, the jetter nozzle assembly 10 in FIG. 1 includes a body 12 of the jetter nozzle 14. The hose fitting 16 is secured at one end to a hose 18. The hose fitting 16 includes a wrench face 20 and also includes an externally threaded portion 22 extending forwardly of the wrench face 20. The body of the jetter nozzle 14 is applied to the external threads of the hose fitting 16 and then rotated so as to engage with the external threads 22. The body 12 of the jetter nozzle 14 will have internal threads which generally match the external threads 22 of the hose fitting 18. Ultimately, as the body 12 is tightened upon the threads 22, a space 24 will exist between the rearward end of the body 12 and the wrench face 20. It is this space 24 that can cause problems as the jetter nozzle assembly enters a drain or sewer line. The wrench face 20 presents a sharp corner 26 at the area of the external threads 22. This corner 26 can abut or adhere to obstructions in the pipe to which the jetter nozzle assembly 10 is applied. These obstructions can, for example, include corrosion or damage to the pipe. As such, the jetter nozzle assembly 10 will hang-up in the line until the obstruction is removed or until the corner 26 is adjusted so as to avoid engagement with the internal surface of the pipe. This inhibits the proper performance of the jetter nozzle assembly 10. Under other circumstances, the sharp corner provided by the rearward end of the body 12 of the jetter nozzle 14 and the corner 26 will prevent the jetter nozzle assembly 10 from being removed from the pipe. Relatively complicated procedures are required so as to free the jetter nozzle assembly 10 from the obstruction in the pipe. Additionally, and furthermore, the orifices on the jetter nozzle 14 will have to be directed further outwardly away from the wrench face 20 so as to avoid interruptions in the laminar flow of water across the surfaces of the jetter nozzle assembly 10. The corner 26, along with the corner between the end of the jetter nozzle 14 and the external threads 22, can disrupt a proper laminar flow of water and, as a result, reduce the effectiveness of the jetter nozzle assembly 10.

FIG. 2 shows another prior art jetter nozzle assembly 30. Once again, the body 32 of the jetter nozzle 34 will have an end 36 that is spaced away from the wrench face 38. As such, the space 40 will occur once the body 32 is tightened upon the external threads 42 of the hose fitting 44. Once again, the exposure of the threads 42 and the sharp corners provided between the body 32 of the jetter nozzle 34 and between the wrench face 38 and the threads 42 will inhibit the proper performance of the jetter nozzle assembly 30.

FIG. 3 shows a cross-sectional view of the configuration of the jetter nozzle assembly 30 upon the threaded portion 50 of the hose fitting 44. The body 32 of the jetter nozzle 34 has internal threads 52 that engage with the external threads 42 of the threaded portion 50. There is a chamber 54 provided within the jetter nozzle 34 so as to allow water to accumulate before being ejected from the jetter nozzle 34 through orifices 56 and 58. Orifice 58 is aligned with the longitudinal axis of the body 32 of the jetter nozzle 34. Orifice 56 will extend at an approximately 45° angle rearwardly. As such, it can be seen that the orifice 56 is directed relatively widely outwardly from the exterior surface 60 of the body 32. This is necessary to avoid interruptions of laminar flow which can occur between the corner 62 formed between the wrench face 38 and the corner 64 formed between the end 66 of the body 32 of the jetter nozzle 34 and the threaded portion 50. In any event, these corners 62 and 64 will remain exposed as the jetter nozzle 34 is moved through the pipe. The jetter nozzle assembly 30 can “hang up” on any internal surfaces of the pipe. Furthermore, the space 40 between the body 32 and the wrench face 38 can prevent the jetter nozzle assembly 30 from traversing through sharp turns within the pipe and, in particular, when the jetter nozzle assembly 30 is used in association with pipes of two inches diameter or less.

Furthermore, since the end 68 of the hose fitting 44 is located relatively far away from the internal chamber 54 of the body 32 of the jetter nozzle 34, a great deal of turbulence can occur prior to the water entering the chamber 34 because of the long distance between the end 68 and the chamber 54. Furthermore, those exposed internal threads 52 can further disrupt the flow of water, create turbulence, and reduce laminar flow of the water. As such, a need has developed so as to reduce the exposure of the external threads 42 on the hose fitting 44 and reduce the exposure of the internal threads 52 on the body 32 of jetter nozzle 34.

In the past, various patents have issued with respect to such jetter nozzles. For example, U.S. Pat. No. 3,165,109, issued on Jan. 12, 1965 to P. Hammelmann, describes an apparatus for the cleaning of sewer systems. This apparatus includes a hose, a nozzle carried by the end of the hose, and a means connected to the hose for supplying cleaning fluid thereto under pressure. A guiding means guides the hose for insertion into a sewer pipe. A cable is attached to the hose adjacent to the nozzle and is guided by the guiding means.

U.S. Pat. No. 3,535,161, issued on Oct. 20, 1970 to R. J. Gutrich, teaches a process and apparatus for clearing sewer lines and the like by application of water at normal household pressures through flexible tubing to a jet-creating head that is connected to the end of the tubing. The jet-creating head is inserted into and passed through the line by means of the tubing. There is a first axial jet head for opening up a passage through the line and a second tangential or swirl jet head for thoroughly cleaning the line.

U.S. Pat. No. 4,322,868, issued on Apr. 6, 1982 to J. C. Wrster, describes a sewer and catch basin cleaner that includes a system for injecting water under pressure into a sewer for cleaning the sewer and a vacuum loading system for removing water and debris from the sewer catch basin. The cleaner includes a water storage tank for providing the cleaning water and a body for receiving the material removed from the catch basin or manhole.

U.S. Pat. No. 5,988,188, issued on Nov. 23, 1999 to J. C. Born, provides a method and apparatus for removing obstruction from sewers without cutters or chemicals. A forwardly-thrusting nozzle is adapted to spray jets of high-pressure, high-temperature water or steam. The nozzle is connected to a hose. The nozzle and hose are inserted through adapter fittings to exit from the outlet opening into a leg of the sewer having the obstruction. A hot water/steam supply connected to the upstream end of the hose provides a supply of steam or hot, pressurized water to the nozzle. The nozzle is advanced through the sewer line to remove the build-up from the sewer walls with the aid of the jets of water.

U.S. Patent Application Publication No. 2016/0089703, issued on Mar. 31, 2016 to the present inventor, describes a sewer jetter apparatus. The sewer jetter apparatus includes a sewer jetter attachment and a sewer jetter hose. A coating is provided over a joint formed by the sewer jetter attachment and the sewer jetter hose. The coating provides a smooth sloped transition between the sewer jetter attachment and the sewer jetter hose. The coating enables improved performance of the sewer jetter apparatus during retraction of the apparatus from a pipe.

It is an object of the present invention to provide a jetter nozzle assembly that has reduced hose fitting exposure.

It is another object the present invention to provide a jetter nozzle assembly that reduces the overall length of the jetter nozzle and hose fitting.

It is another object the present invention to provide a jetter nozzle assembly that improves laminar flow of liquid across the hose fitting and along the internal surfaces of the jetter nozzle.

It is another object of the present invention to provide a jetter nozzle assembly that reduces the sticking of the wrench face against objects, such as corrosion or structural damage, in the drain line and elbow.

It is a further object of the present invention to provide a jetter nozzle assembly that allows the jetter nozzle to be tightened to the full depth of threads of the hose fitting.

It is further object the present invention to provide a jetter nozzle assembly that improves travel of the jetter nozzle assembly through drain elbows.

It is a further object the present invention to provide a jetter nozzle assembly that provides a maximum pulling and cleaning force during the movement of the jetter nozzle assembly through the pipe.

It is a further object of the present invention provide a jetter nozzle assembly that is able to navigate in elbows of less than three inches radius.

These and other objects and advantages of the present invention will become apparent from a reading of the attached specification and appended claims.

### BRIEF SUMMARY OF THE INVENTION

The present invention is a jetter nozzle that comprises a body having a plurality of orifices opening to an exterior of the body and a sleeve extending from one end of the body. The plurality of orifices are adapted to release a liquid from an interior of the body. The sleeve has an internally threaded portion adjacent to the body and an unthreaded portion adjacent to an end of the sleeve opposite the body. The threaded portion is adapted to engage with some external threads of the hose fitting. The end of the sleeve is adapted to be positioned adjacent to a wrench face of the hose fitting and reside over the other external threads of the hose fitting.

The sleeve has an outer diameter approximately equal to an outer diameter of the hose fitting. The sleeve has an internal diameter slightly greater than an outer diameter of the external threads of the hose fitting.

The body has a chamber therein. The plurality of orifices open to the chamber. The chamber is adapted to receive the liquid that is released from the hose fitting. The sleeve is adapted to extend to an end of the hose fitting. The sleeve has the end adjacent to the wrench face tapered inwardly. The sleeve can, in one embodiment, cover all of the external threads of the hose fitting. The sleeve is integral with the body.

The plurality of orifices open rearwardly of the chamber so as to direct the flow of pressurized liquid in a direction toward the hose fitting. The plurality of orifices extend at an angle of between 18° and 45° relative to a longitudinal axis of the jetter nozzle. In the preferred embodiment of the present invention, each of the plurality of orifices extend at an angle of thirty-five degrees. Also, in the preferred embodiment, the plurality of orifices comprise three orifices that are in evenly circumferentially spaced relation to each other. Additionally, at least one of the plurality of orifices can comprise a single orifice formed at a forward end of the body and aligned with the longitudinal axis of the jetter nozzle.

This foregoing Section is intended to describe, with particularity, the preferred embodiments of the present invention. It is understood that modifications to these preferred embodiments can be made within the scope of the present claims without departing from the true spirit of the invention. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a side elevational view of one form of the jetter nozzle assembly of the prior art.

FIG. 2 is a side elevational view of another jetter nozzle assembly in accordance with the prior art.

FIG. 3 is a cross-sectional view of the jetter nozzle assembly shown in FIG. 2.

FIG. 4 is a side elevational view of the jetter nozzle assembly in accordance with the present invention.

FIG. 5 is a side cross-sectional view of the jetter nozzle assembly in accordance with the teachings of the present invention.

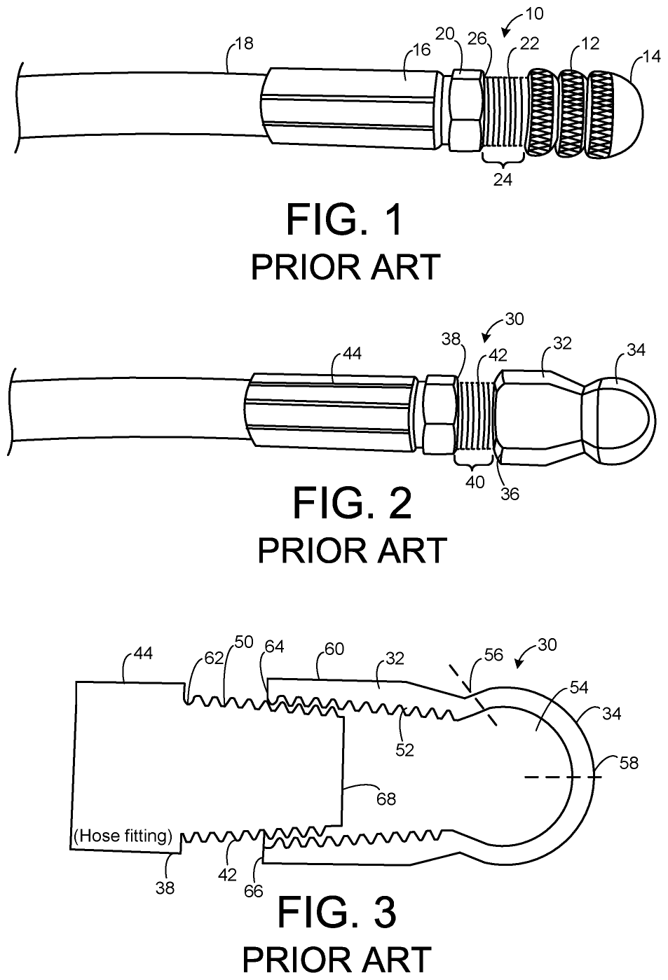

### DETAILED DESCRIPTION OF THE INVENTION

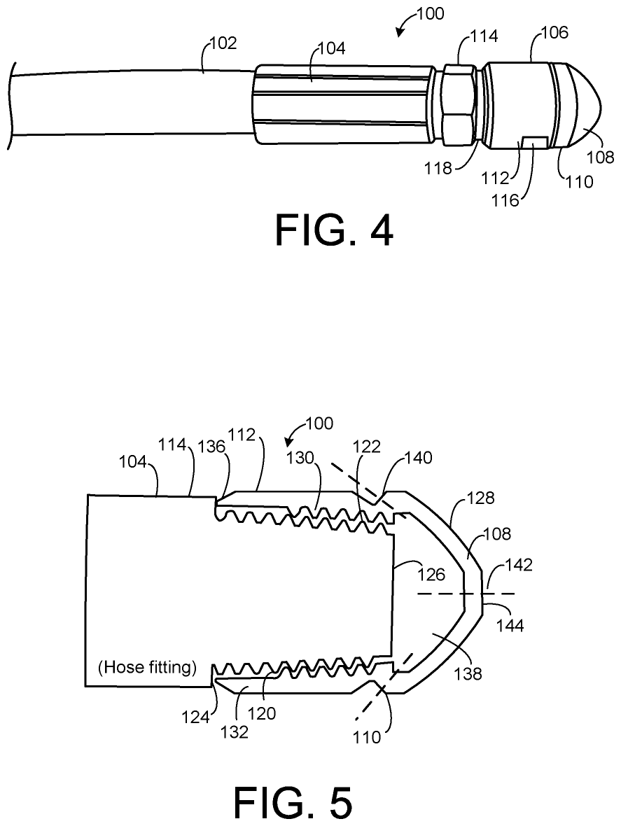

Referring to FIG. 4, there is shown the jetter nozzle assembly 100 in accordance with the present invention. The jetter nozzle assembly 100 includes a hose 102, a hose fitting 104 and a jetter nozzle 106. The hose fitting 104 is rigidly secured on to the end of the hose 102. The jetter nozzle 106 has a body 108 with a plurality of orifices 110 opening to the exterior of the body 108. The plurality of orifices 110 are adapted to release a pressurized liquid from the interior of the body 108. A sleeve 112 extends from one end of the body 108. As will be described hereinafter, the sleeve 112 will have an internally threaded portion adjacent to the body 108 and an unthreaded portion adjacent to an end of the sleeve 112 opposite the body 108. The threaded portion is adapted to engage with some external threads of the hose fitting 104. An end of the sleeve 112 is adapted to be positioned adjacent to a wrench face 114 of the hose fitting 104 and reside over the external threads of the hose fitting 104.

As can be seen in FIG. 4, the wrench face 104 has a generally hexagonal configuration adapted to receive a wrench. The sleeve 112, which is integrally affixed to the body 108, has flats 116 thereon so that a wrench can be applied thereto. A rotation of the sleeve 112 (along with the body 108) will cause the internal threads of the sleeve 112 to be threadedly secured to the external threads protruding from the hose fitting 104.

As can be seen in FIG. 4, there is a very small area 118 formed between the end of the sleeve 112 and the wrench face 114. This very small amount of distance will avoid those instances where the wrench face 114 could become trapped or interfered with by an external object or another surface within the pipe to which the jetter nozzle assembly 100 is applied. The sleeve 112 will be generally flush with the wrench face 114. In other words, the sleeve 112 will have an external diameter generally matching the external diameter of the wrench face 114 and of the hose fitting 104. As such, this smooth configuration will facilitate the ability of the jetter nozzle assembly 100 to slide within the interior of a sewer, pipe, or drain. Under those circumstances where the jetter nozzle assembly 100 is applied to small elbows (of less than three inch radius), the jetter nozzle assembly 100 will smoothly pass through this small area. The length of the assembly including the hose fitting 104, the wrench face 114, the sleeve 112 and the body 108 will be minimal since the end of the sleeve 112 will be positioned adjacent to the wrench face 114 and will not reveal exposed external threads. This smooth configuration will create an improved laminar flow for liquid that is expelled through the plurality of orifices 110. This water will flow without being interrupted by the sharp surfaces associated by the external threads or the wrench face 114. Also, the orifices 110 can be directed at a shallower angle than previous jetter nozzles since there is less interference with the laminar flow of liquid by the structures following the nozzles. This can create a greater and more even pushing force.

FIG. 5 shows a cross-sectional view of the jetter nozzle assembly 100 of the present invention. FIG. 5 shows the hose fitting 104 having a threaded section 120. External threads 122 are formed on the threaded section 120. A shoulder 124 is formed at the juncture of the hose fitting 104 and the threaded portion 120. The end 126 of the hose fitting 114 will have a suitable opening therein so as to allow pressurized liquid to be released therefrom and into the interior of the jetter nozzle 128.

Jetter nozzle 128 includes the body 108 and the sleeve 112 integrally formed together. Internal threads 130 are formed on a portion of the length of the sleeve 112. As such, the portion of the sleeve 112 upon which the internal threads 130 appear will be considered to be the “threaded section”. There is an unthreaded section 132 that extends rearwardly from the threaded section 130. As such, the inner diameter of the unthreaded section 132 will reside over the peaks of each of the external threads 122 on the threaded section 120 of the hose fitting 104. Ultimately, the end 136 of the sleeve 112 will reside very closely against the shoulder 124 of the hose fitting 104. The end of the sleeve 112 will taper inwardly toward the end 136 so as to create a smooth transition between the external diameter of the sleeve 112 and the external diameter of the wrench face 114 of hose fitting 104.

The body 108 has a chamber 138 formed in the interior thereof. As water is released from the end 126 of the threaded section 120, it is directed under pressure immediately into the chamber 138. The pressurized liquid is then released through the orifices 110 and 140 at an angle (with respect to the longitudinal axis of the hose fitting 104 or the jetter nozzle 128) of between 18° and 45°. In the preferred embodiment the present invention, each of these orifices extend at an angle of 35°. In the preferred embodiment of the present invention, the plurality of orifices that face rearwardly will be three in number. However, it is possible that a greater number of orifices or a smaller number of orifices could be used within the present invention. Each of these orifices 110 and 140 opens to the chamber 138. Another orifice 142 can be formed at the forward face 144 of the body 108. Although the orifice 142 is not required, under certain circumstances, a user may desire to have the pressurized liquid directed in a forward manner so as to potentially remove debris forward of the jetter nozzle assembly 100. The orifice 142 is aligned with the longitudinal axis of the jetter nozzle assembly 100.

In FIG. 5, it can be seen that the liquid released from the end 126 of the hose fitting 104 passes immediately into the chamber 138. It is not disrupted by any contact with the internal threads of the sleeve 112. As such, once again, there is no disruption of the laminar flow of liquid into the jetter nozzle assembly of the present invention.

The present invention provides a jetter nozzle assembly which is a great improvement over the prior art. The present invention minimizes the number of exposed threads on the jetter nozzle assembly. As such, this greatly improves the smooth exterior characteristics of the jetter nozzle assembly. Also, this facilitates the ability of the jetter nozzle assembly to easily slide through pipes, drains, and sewers without being prevented from moving by internal obstructions within such pipe. Furthermore, the improved laminar fluid dynamics associated with the jetter nozzle assembly of the present invention improves the “cutting ability” of the pressurized stream of liquid emitted by the orifices of the jetter nozzle.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A jetter nozzle comprising:
a body having a plurality of orifices opening to an exterior of said body, the plurality of orifices adapted to release a pressurized liquid from an interior of said body; and
a sleeve extending from one end of said body, said sleeve having an internally threaded portion adjacent said body and an unthreaded portion adjacent an end of said sleeve opposite said body, said threaded portion being adapted to engage with some external threads of a hose fitting, the end of the sleeve adapted to be positioned adjacent a wrench face of the hose fitting and to reside over other external threads of the hose fitting.

2. The jetter nozzle of claim 1, said sleeve having an outer diameter approximately equal to an outer diameter of the hose fitting.

3. The jetter nozzle of claim 1, said sleeve having an internal diameter slightly greater than an outer diameter of the other external threads of the hose fitting.

4. The jetter nozzle of claim 1, said body having a chamber therein, the plurality of orifices opening to the chamber, the chamber adapted to receive the liquid released from the hose fitting.

5. The jetter nozzle of claim 1, said sleeve adapted to extend to an end of the hose fitting.

6. The jetter nozzle of claim 1, said sleeve having the end adjacent the wrench face tapered inwardly.

7. The jetter nozzle of claim 1, said sleeve covering all of the external threads of the hose fitting.

8. The jetter nozzle of claim 4, the plurality of orifices opening rearwardly of said chamber so as to direct a flow of pressurized liquid in a direction toward the hose fitting.

9. The jetter nozzle of claim 8, the plurality of orifices extending at an angle of between 18° and 45° relative to a longitudinal axis of the jetter nozzle.

10. The jetter nozzle of claim 9, the angle being 35°.

11. The jetter nozzle of claim 8, the plurality of orifices comprising three orifices in evenly circumferentially spaced relationship to each other.

12. The jetter nozzle of claim 1, at least one of said plurality of orifices comprising a single orifice formed at a forward end of said body and aligned with a longitudinal axis of the jetter nozzle.

13. The jetter nozzle of claim 1, said sleeve being integral with said body.

14. A jetter nozzle assembly comprising:
a hose having a hose fitting at one end thereof, the hose fitting having external threads thereon and a wrench face positioned rearwardly of the external threads;
a body having a plurality of orifices opening to an exterior of said body, the plurality of orifices adapted to release a pressurized liquid from an interior of said body; and
a sleeve extending from an end of said body, said sleeve having an internally threaded portion adjacent to said body and an unthreaded portion adjacent an end of said sleeve opposite said body, the threaded portion engaging with some of the external threads of the hose fitting, the end of said sleeve positioned adjacent the wrench face of the hose fitting and residing over other external threads of said hose fitting.

15. The jetter nozzle assembly of claim 14, said sleeve having an outer diameter approximately equal to an outer diameter of the hose fitting.

16. The jetter nozzle assembly of claim 14, said body having a chamber therein, the plurality of orifices opening to the chamber, the chamber adapted to receive the liquid released from said hose fitting.

17. The jetter nozzle assembly of claim 14, said sleeve extending to an end of said hose fitting.

18. The jetter nozzle assembly of claim 14, said sleeve covering all of the external threads of said hose fitting.

19. The jetter nozzle assembly of claim 14, the plurality of orifices opening rearwardly of said chamber so as to direct a flow of the pressurized liquid in a direction toward said hose fitting.

20. The jetter nozzle assembly of claim 14, said sleeve being integral with said body.
